(19) United States
(12) Patent Application Publication
(10) Pub. No.: US 2007/0272229 A1
(43) Pub. Date: Nov. 29, 2007

(54) Barbecue grill with biomass gasifier combustion unit as charcoal starter or heat source

(75) Inventors: James Bernard Becker, Centennial, CO (US); Shivayam Ellis, Denver, CO (US)

Correspondence Address: James B. Becker;Manager Spenton LLC, C18 - Suite 208, 5910 S. University Blvd., Greenwood Village, CO, 80121, US

(73) Assignee: Spenton LLC

(21) Appl. No.: 11/441,441

(22) Filed: May 26, 2006

(51) Int. Cl. A47J 37/00; A47J 37/07

(52) U.S. Cl. 126/25 B

(57) ABSTRACT

Barbecue grill consisting of housing containing possible charcoal rack and one or more cooking grills. Attached below housing is a biomass gasifier/combustion unit providing charcoal starting and combustion air control for charcoal combustion or providing primary heat for cooking.

### CROSS-REFERENCE

not applicable

### FEDERALLY SPONSORED RESEARCH

not applicable

### SEQUENCE LISTING or PROGRAM

not applicable

### BACKGROUND OF THE INVENTION

The present invention relates to a barbecue grill. More particularly, the invention relates to use of biomass in operation or starting of a barbecue grill.

### PRIOR ART

Biomass or wood burning barbecues are well known in the prior art. However, none of them use a biomass gasification/combustion process to remove pollution and increase efficiency.

Charcoal starters are also well known in the prior art. However, none use biomass gasification/combustion to preheat charcoal—a process for starting charcoal much faster than other methods.

### OBJECTS AND ADVANTAGES

Barbecue grills have one of two problems. First, they use fuel, such as propane, methane or charcoal which are costly. Second, if charcoal is used, it takes considerable time and effort to start charcoal combustion.

This invention attempts to solve the problem of expensive fuel by creating a grill which uses readily available waste biomass, such as twigs, pine-cones or commercially available fuel such as wood pellets. The invention may also be used to solve the problem of starting charcoal by using the combustion of biomass to start charcoal quickly and easily.

As shown in FIG. 1, an apparatus currently in the public domain gasifies biomass, then burns the resultant gas directly above the gasification process. The most common product available using this apparatus is known as the WoodGas™ camp stove. The public domain apparatus uses this combined gasification/combustion process to create efficient and low pollution heat from available biomass.

Limitations to this design prevent it from being used as a general cooking device. The top of the device is small and does not support large cooking appliances. The device also does not directly grill meat or other food without the use of a cooking pan.

As shown in FIG. 2, this patent combines the gasification/combustion unit to a regular barbecue grill apparatus to provide a convenient cooking surface. And, if the user so chooses, the gasification/combustion unit can be used to quickly and easily start charcoal combustion within the barbecue grill.

### SUMMARY

By combining a traditional barbecue grill with a biomass gasification/combustion unit, barbecues can efficiently use inexpensive biomass as fuel with very little pollution, or a user may be able to start charcoal quickly and easily.

### DRAWINGS

FIG. 1 shows a cross section of the public domain biomass gasification/combustion unit.

FIG. 2 shows a cross sections of the biomass gasification/combustion unit attached to a traditional barbecue grill.

### DETAILED DESCRIPTION

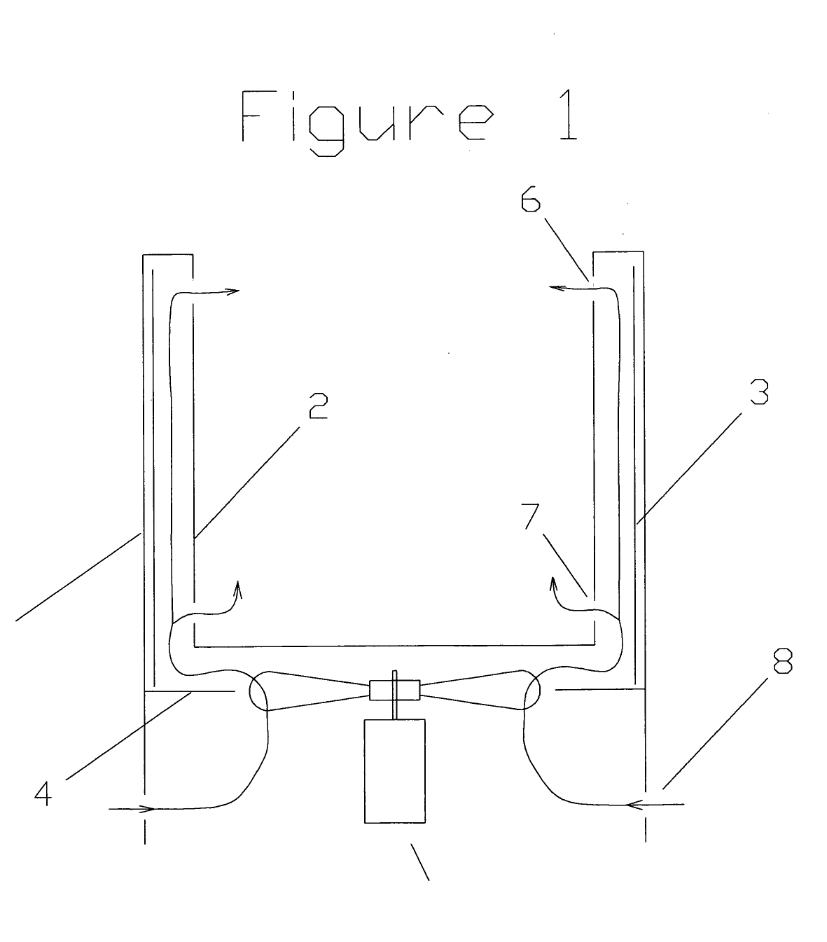

The public domain gasification/combustion unit, as shown in FIG. 1, consists of an outer can (1), an inner can (2), a heat shield between the inner and outer cans (3), a fan disposed below the inner can (5) and a fan shroud (4) separating outer air pressure from air pressure ahead of the fan. Gasification air ports (7) are provided adjacent to the bottom in the inner can. Combustion air ports (6) are provided adjacent to the top of the inner can.

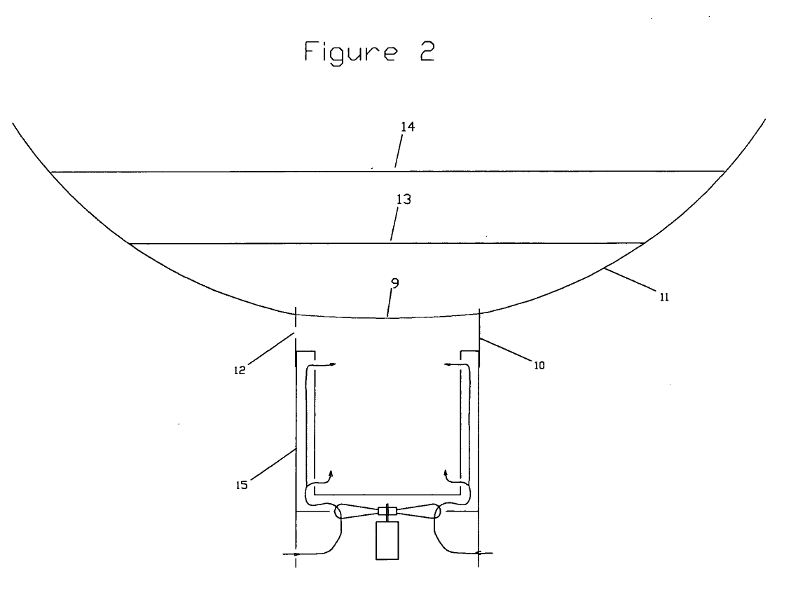

The barbecue grill, as shown in FIG. 2, consists of an outer member (11) with optional racks (13) for holding charcoal, and one or more racks (14) for holding and cooking food and an opening near the bottom (9). An optional tubular member (10) is affixed to the opening of the barbecue grill with the gasification/combustion unit (15) disposed inside of the tubular member or disposed below the bottom opening. An optional port (12) in the side of the tubular member is provided to allow ignition materials to be inserted in order to start the biomass/combustion unit in operation.

### OPERATION

In use, biomass fuel such as twigs, pellets, or wood chips are loaded into the biomass gasification/combustion unit, with tinder placed on top. The tinder is then ignited and the fan of the gasification/combustion unit is turned on. Optionally, the user may then add charcoal to the grill above the gasification/combustion unit. The tinder is then started with a match or lighter and the fan is started in the gasification/combustion unit. The grill is then ready for cooking.

I claim:

1. A barbecue grill comprising:
a) a main housing containing one or more housings or racks for grilling food, and optionally racks or housings for holding charcoal,
b) an opening in bottom of said main housing,
c) a combined biomass gasifier/combustion unit disposed below and fitted to said opening of said main housing.

2. The barbecue grill of claim 1, further including:
An ignition opening at the side of said charcoal grill housing disposed above gasifier/combustion unit provides means of inserting ignition material to start said gasifier/combustion unit,
a sliding or rotating member to close said ignition opening.

3. The barbecue grill of claim 2, further including:
High temperature RTV seal between said gasifier/combustion unit and said housing opening to prevent air leakage into said housing.

4. The barbecue grill of claim 1, wherein:
The gasification/combustion unit is disposed below said charcoal grill with a gap between said barbecue grill and gasification/combustion unit.

5. The barbecue grill of claim 1, wherein:
Protruding down from said opening of said main housing, a cylindrical body with open top and bottom,
said biomass gasifier/combustion unit fitted to said protruding body, an ignition opening at side of said protruding body above said gasification/combustion unit for insertion of ignition device to start said gasifier/combustion unit,
a sliding or rotating member to close said ignition hole.

6. The barbecue grill of claim 5, further including:
RTV seal between said gasifier/combustion unit and protruding body to prevent air leaking into protruding body.

7. A barbecue grill comprising:
a) a main housing containing other housings and/or racks for charcoal combustion and one or more housings or racks for grilling food,
b) a combined biomass gasifier/combustion unit enclosed within said main housing.
